(19) United States
(12) Patent Application Publication
(10) Pub. No.: US 2024/0135354 A1
(43) Pub. Date: Apr. 25, 2024

(54) CHECKOUT SYSTEM, CHECKOUT MACHINE, AND CONTROL METHOD THEREFOR

(71) Applicant: Toshiba Tec Kabushiki Kaisha, Tokyo (JP)

(72) Inventor: Hiroyuki KATSUMATA, Numazu Shizuoka (JP)

(21) Appl. No.: 18/450,016

(22) Filed: Aug. 14, 2023

(30) Foreign Application Priority Data
Oct. 20, 2022 (JP) 2022-169248

(51) Int. Cl. G06Q 20/20

(52) U.S. Cl. CPC G06Q 20/20

(57) ABSTRACT

According to an embodiment, a checkout machine receives information related to a transaction of a commodity to be purchased by a customer from a register. The checkout machine settles the transaction of the commodity on the basis of the information related to the transaction of the commodity. The checkout machine notifies the register of the fact that the information related to the transaction is receivable at a time point at which a standby period has elapsed after the settlement is finished. Further, the checkout machine changes the standby period in accordance with information of the customer who is a target of the settled transaction.

### CROSS-REFERENCE TO RELATED APPLICATIONS

This application is based upon and claims the benefit of priority from the prior Japanese Patent Application No. 2022-169248, filed on Oct. 21, 2022, the entire contents of which are incorporated herein by reference.

### FIELD

Embodiments described herein generally relate to a checkout system, a checkout machine of the checkout system, and a control method therefor.

### BACKGROUND

In recent years, semi-self-service checkout systems have attracted attention in retail stores such as supermarket from the viewpoint of reduction in labor, efficiency, and the like. In the semi-self-service checkout system, a register that registers commodities to be purchased by a customer, and a checkout machine that receives payment for the commodities to be purchased and settles a buying and selling transaction with the customer are separately provided. In the semi-self-service checkout system, a store clerk who is an employee of the store operates the register, and the customer operates the checkout machine.

In the semi-self-service checkout system, the register transmits information related to a transaction of the commodities registered by the register to the checkout machine. The checkout machine settles the transaction on the basis of the information related to the transaction of the commodities, which has been received from the register. Note that at the stage at which the settlement of a transaction with a previous customer is not finished, the checkout machine is incapable of receiving information related to a transaction of the next customer and processing settlement. In this regard, in a conventional semi-self-service checkout system, after finishing settlement of a transaction with a customer, a checkout machine notifies the register of the fact that information related to a transaction is receivable, and the register transmits information related to a transaction to a checkout machine capable of receiving the information.

However, a customer who has finished the settlement is slow in putting change, a receipt, a card, or the like in a wallet or the like and thus continues standing in front of the checkout machine in some cases. In such a case, even though information related to a transaction of the next customer has been transmitted from the register to the checkout machine, the next customer is unable to operate the checkout machine to settle the transaction because the previous customer is located near the checkout machine. In addition, information necessary to settle the transaction with the next customer is displayed on the checkout machine, and thus there is a risk that the previous customer and the next customer are confused. It is highly possible that such a situation occurs when the previous customer is an elderly person or disabled person.

### BRIEF DESCRIPTION OF THE DRAWINGS

FIG. 1 is a schematic diagram showing a schematic configuration of a checkout system according to a first embodiment.

FIG. 2 is a schematic diagram showing a data structure of a setting file according to the first embodiment.

FIG. 3 is a block diagram showing a circuit of a main part of a register according to the first embodiment.

FIG. 4 is a schematic diagram showing a data structure of a state table according to the first embodiment.

FIG. 5 is a block diagram showing a circuit of a main part of a checkout machine according to the first embodiment.

FIG. 6 is a schematic diagram showing a sequence of information exchanged between the register and the checkout machine according to the first embodiment and a status transition indicating a state of the checkout machine.

FIG. 7 is a flowchart showing information processing executed by a processor of the register according to the first embodiment.

FIG. 8 is a flowchart showing response receiving processing of the information processing executed by the processor of the register according to the first embodiment.

FIG. 9 is a flowchart showing information processing executed by a processor of the checkout machine according to the first embodiment.

FIG. 10 is a block diagram showing a circuit of a main part of a register according to a second embodiment.

FIG. 11 is a flowchart showing information processing executed by a processor according to the second embodiment.

FIG. 12 is a block diagram showing a circuit of a main part of a checkout machine according to a third embodiment.

FIG. 13 is a flowchart showing information processing executed by a processor of the checkout machine according to the third embodiment.

FIG. 14 is a schematic diagram showing a data structure of a setting file according to a fourth embodiment.

FIG. 15 is a flowchart showing information processing executed by a processor of a checkout machine according to the fourth embodiment.

### DETAILED DESCRIPTION

According to one embodiment, a checkout machine performs settlement by an operation of a customer on the basis of information related to a transaction of a commodity to be purchased by the customer, the information related to the transaction being acquired from a register. The checkout machine includes a communication interface, a memory, a timer, and a processor. The communication interface performs data communication with the register. The memory stores a standby period. The standby period is a time period that elapses, from a time point at which the settlement is finished, before notifying the register of a fact that the information related to the transaction of the commodity to be purchased is receivable. The processor receives the information related to the transaction of the commodity to be purchased from the register via the communication interface. The processor acquires information of a customer who performs an operation for the settlement. The processor determines the standby period corresponding to the acquired information of the customer and stores the standby period in the memory. The processor settles the transaction of the commodity to be purchased on the basis of the information related to the transaction of the commodity to be purchased. The processor determines, using the timer, whether or not the standby period stored in the memory has elapsed from the time point at which the settlement is finished. Further, the processor transmits a notification indicating that the information related to the transaction of the commodity to be purchased is receivable to the register via the communication interface at a time point at which the standby period has elapsed.

Hereinafter, some embodiments of a checkout system including a checkout machine capable of varying a timing for notifying a register of the fact that information related to a transaction is receivable, depending on a customer who has finished settlement, will be described with reference to the drawings. In the drawings, the same reference symbols represent the same or similar portions.

### First Embodiment

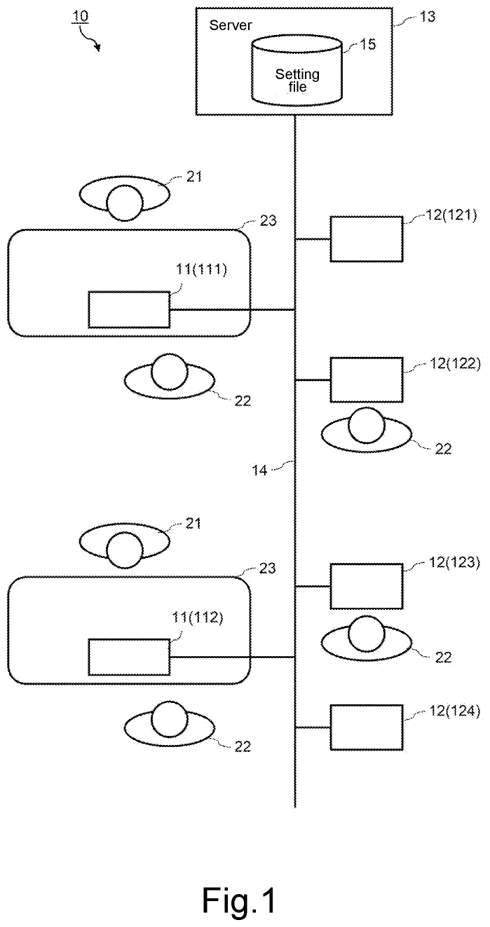

First, a first embodiment will be described with reference to FIGS. 1 to 9.

(Description of Configuration)

FIG. 1 is a schematic diagram showing a schematic configuration of a checkout system 10 according to a first embodiment. The checkout system 10 includes a register 11, a checkout machine 12, a server 13, and a network 14 that connects those components to each other. The type of network 14 is not particularly limited, but a wired or wireless local area network (LAN) is generally applied.

An operator of the register 11 is a store clerk 21 who plays a role called a checker. An operator of the checkout machine 12 is a customer 22 who purchases commodities in the store. The customer 22 who operates the checkout machine 12 to settle a buying and selling transaction can also be referred to as a settler, a purchaser, or the like. Note that the transaction is not limited to payment for commodities to be purchased. For example, payment of consideration for a service is also an aspect of the transaction.

In FIG. 1, the register 11 is mounted onto a work table 23. The work table 23 includes a rectangular top panel. A plurality of work tables 23 are disposed such that the top panels thereof are substantially parallel to each other in the longitudinal direction thereof, thus forming a passage for the customer 22, which is a so-called checkout lane.

The register 11 and the checkout machine 12 are disposed for each checkout lane. For a single checkout lane, a single register 11 and a plurality of checkout machines 12 are disposed. The register 11 transmits information related to a buying and selling transaction to a checkout machine 12 disposed in the same checkout lane. The register 11 may transmit information related to a transaction to the checkout machine 12 via the server 13 or may transmit information related to a transaction to the checkout machine 12 without intervention of the server 13. Further, the register 11 is also capable of transmitting information related to a transaction to not only the checkout machine 12 disposed in the same checkout lane but also a checkout machine 12 disposed in an adjacent checkout lane.

Incidentally, FIG. 1 shows an example in which the single register 11 and the two checkout machines 12 are disposed for each of two checkout lanes. Specifically, a single register 11 (111) having a register ID “111” and two of a checkout machine 12 (121) and a checkout machine 12 (122) respectively having checkout machine IDs “121” and “122” are disposed in a single checkout lane, and a single register 11 (112) having a register ID “112” and two of a checkout machine 12 (123) and a checkout machine 12 (124) respectively having checkout machine IDs “123” and “124” are disposed in another checkout lane. In such an arrangement, in this embodiment, one register 11 (111) is capable of transmitting information related to a transaction to the checkout machine 12 (123) of the adjacent checkout lane, in addition to the checkout machine 12 (121) and the checkout machine 12 (122) in the same checkout lane. Similarly, the other register 11 (112) is capable of transmitting information related to a transaction to the checkout machine 12 (122) of the adjacent checkout lane, in addition to the checkout machine 12 (123) and the checkout machine 12 (124) in the same checkout lane.

Note that the register ID is a unique identifier that is set for each register 11 so as to individually identify the registers 11. The checkout machine ID is a unique identifier that is set for each checkout machine 12 so as to individually identify the checkout machines 12.

The server 13 includes a setting file 15. The setting file 15 may be saved in a storage device incorporated in the server 13 or may be saved in a storage device externally connected to the server 13.

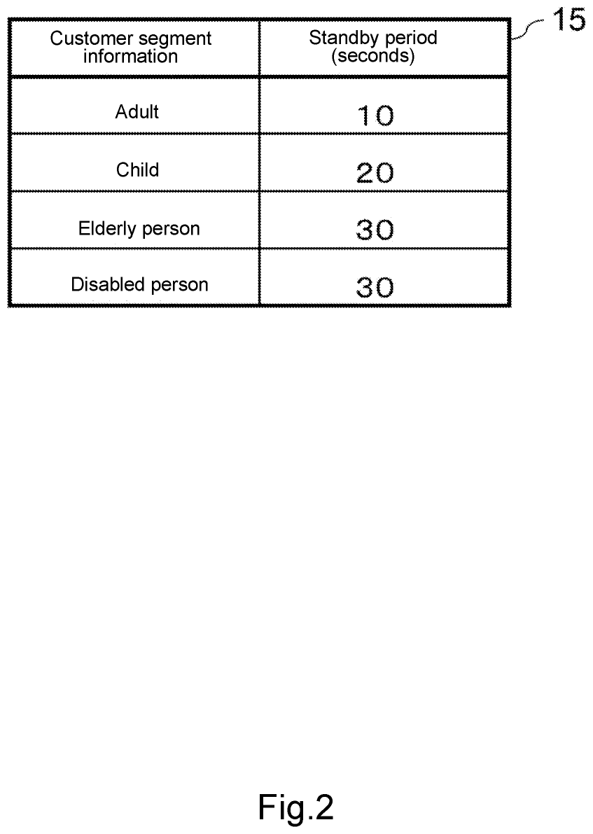

FIG. 2 is a schematic diagram showing a data structure of the setting file 15. The setting file 15 is a data file in which customer segment information and a standby period (seconds) are stored in association with each other. The customer segment information has four types of “adult”, “child”, “elderly person”, and “disabled person”. The standby period is a waiting period of the checkout machine 12, which elapses after settlement completion of a transaction and before notifying the register 11 of the fact that information related to a transaction of the next customer is receivable.

In general, as compared with an adult as an able-bodied person, an elderly person and a disabled person tend to need a longer time to finish settlement in the checkout machine 12 and then move away from the front of the checkout machine 12. In this embodiment, the standby period associated with the customer segment information is assumed as an estimated time period, during which a customer belonging to that customer segment information moves away from the front of the checkout machine 12 certainly. In other words, an able-bodied adult who does not belong to the elderly person is estimated to move away from the front of the checkout machine 12 within at most 10 seconds, and thus the standby period for the customer segment information “adult” is set to 10 seconds. A child of an elementary age or younger is estimated to move away from the front of the checkout machine 12 within at most 20 seconds even if the child is somewhat slow in performing processing, and thus the standby period for the customer segment information “child” is set to 20 seconds. Meanwhile, an elderly person may need approximately 30 seconds before moving away from the front of the checkout machine 12 because of being slow in performing processing or failing to taking a prompt action. Further, a disabled person having a disability in arms or legs may also need time before moving away from the front of the checkout machine 12, similarly to the elderly person.

In this regard, in this embodiment, the server 13 includes the setting file 15 in which the standby period for the customer segment information “adult” is set to 10 seconds, the standby period for the customer segment information “child” is set to 20 seconds, and the standby period for the customer segment information “elderly person” and “disabled person” is set to 30 seconds. Note that the customer segment information and the standby period associated therewith are examples. Further, the definitions of “adult”, “child”, “elderly person”, and “disabled person” are not particularly determined. In the first embodiment, the store clerk who operates the register 11 determines a customer segment by observing a customer.

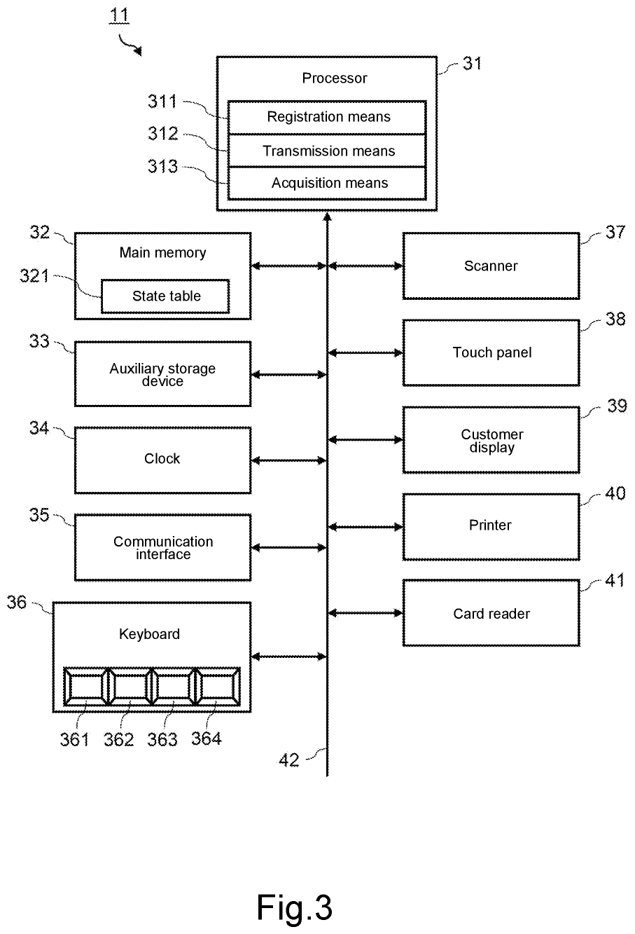

FIG. 3 is a block diagram showing a circuit of a main part of the register 11. The register 11 includes a processor 31, a main memory 32, an auxiliary storage device 33, a clock 34, a communication interface 35, a keyboard 36, a scanner 37, a touch panel 38, a customer display 39, a printer 40, a card reader 41, a system transmission path 42, and the like. The system transmission path 42 includes an address bus, a data bus, a control signal line, and the like. The system transmission path 42 connects the processor 31 and the other units to each other directly or via a signal input/output circuit and transmits data signals to be exchanged therebetween.

The register 11 connects the processor 31 with the main memory 32, the auxiliary storage device 33, the clock 34, and the communication interface 35 by the system transmission path 42, thus constituting a computer. The register 11 then connects the devices such as the keyboard 36, the scanner 37, the touch panel 38, the customer display 39, the printer 40, and the card reader 41 to the computer via the system transmission path 42.

The processor 31 corresponds to the central portion of the computer. The processor 31 controls the units so as to implement various functions as the register 11 according to the operating system or an application program. The processor 31 is favorably of a multi-core or multithread type capable of performing a plurality of types of processing in parallel. The processor 31 is, for example, a central processing unit (CPU).

The main memory 32 corresponds to a main storage portion of the computer. The main memory 32 includes a nonvolatile memory area and a volatile memory area. The main memory 32 stores the operating system or the application program in the nonvolatile memory area. The main memory 32 may store data, which is necessary for the processor 31 to execute processing for controlling the units, in the nonvolatile or volatile memory area. The processor 31 uses the volatile memory area of the main memory 32 as a work area in which data is appropriately rewritten. The nonvolatile memory area is, for example, a read only memory (ROM). The volatile memory area is, for example, a random access memory (RAM).

The auxiliary storage device 33 corresponds to an auxiliary storage portion of the computer. For example, an electric erasable programmable read-only memory (EEPROM), a hard disk drive (HDD), a solid state drive (SSD), or the like can be the auxiliary storage device 33. The auxiliary storage device 33 saves data used by the processor 31 to perform various types of processing, data created in the processing by the processor 31, and the like. The auxiliary storage device 33 may store the application program.

The clock 34 counts date and time. The processor 31 processes the date and time counted by the clock 34 as current date and time.

The communication interface 35 performs data communication with the server 13 and the checkout machines 12 connected via the network 14. The communication interface 35 is also capable of performing data communication with another register 11 connected via the network 14.

The keyboard 36 is an input device in which various keys necessary for inputting data related to commodities to be purchased by a customer are disposed. The keys include an adult key 361, a child key 362, an elderly person key 363, and a disabled person key 364 respectively corresponding to the four types of customer segment information stored in the setting file 15. If determining that a customer who comes for checkout is classified as an adult, the store clerk who is the operator of the register 11 operates the adult key 361 for input. Similarly, if determining that the customer is classified as a child, the store clerk operates the child key 362 for input; if determining that the customer is classified as an elderly person, the store clerk operates the elderly person key 363 for input; and if determining that the customer is classified as a disabled person, the store clerk operates the disabled person key 364 for input.

The scanner 37 is an input device for reading a code symbol such as a bar code or a two-dimensionally code. The scanner 37 may be of a type that reads a code symbol by scanning of laser light or may be of a type that reads a code symbol from an image captured by an imaging device.

The touch panel 38 is a display device capable of displaying display elements including characters, symbols, images, and the like on the display. Further, the touch panel 38 is also an input device that detects a touched position on the display by a sensor and performs processing on the assumption that a display element at that position is input. The touch panel 38 displays information to the store clerk as the operator of the register 11 and receives an operation input by the store clerk.

The customer display 39 is a display device provided to display information such as a commodity name, a price, or the like of the commodity registered by the register 11 to the customer 22.

The printer 40 is an output device that prints data related to a purchase receipt, a credit card bill, or the like onto receipt paper. The receipt paper on which various types of data are printed by the printer 40 is cut by a cutter and issued from a receipt issuing port. The printer 40 is constituted by, for example, a thermal printer or a dot impact printer.

The card reader 41 is an input device that reads data recorded on a card medium such as a credit card, an electronic money card, or a rewards card. If the card medium is a magnetic card, the card reader 41 is a magnetic card reader. If the card medium is an IC card, the card reader 41 is an IC card reader. The register 11 may include either one or both of a magnetic card reader and an IC card reader as the card reader 41. The card reader 41 may be a card reader/writer having a function of writing data to a card.

As the hardware of such a register 11, for example, an existing POS terminal can be used. Note that the devices connected to the register 11 are not limited to the keyboard 36, the scanner 37, the touch panel 38, the customer display 39, the printer 40, and the card reader 41 shown in FIG. 3. It may also be possible to add devices necessary for use application of the register 11 or omit some devices.

The register 11 uses a part of the volatile memory area of the main memory 32 as an area of a state table 321. The state table 321 is an area for storing information indicating the states of the plurality of checkout machines 12 connected to the register 11.

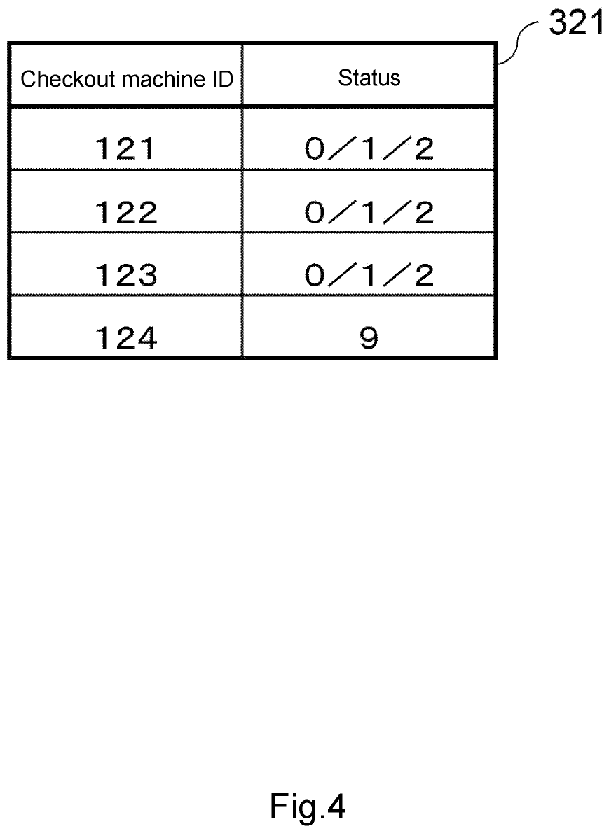

FIG. 4 is a schematic diagram showing a data structure of the state table 321. As shown in FIG. 4, the state table 321 stores a status in association with the checkout machine ID. The status is information indicating a state of the checkout machine 12 identified by a corresponding checkout machine ID. Specifically, in the status, the value “0” indicates a state in which the checkout machine 12 is capable of receiving information related to a transaction, the value “1” indicates a state in which the checkout machine 12 is performing settlement processing, and the value “2” indicates a state in which the checkout machine 12 is standby after completion of the settlement. Further, the status of the checkout machine 12, to which information related to a transaction is not transmitted, is “9”. FIG. 4 shows the state table 321 of the register 11 (111) having a register ID “111”. In a state table 321 of the register 11 (112) having a register ID “112”, the checkout machine 12 (121) having a checkout machine ID “121” has a status “9”, and the other checkout machines 12 each have a status “0”, “1”, or “2”.

Return to the description of FIG. 3. The register 11 mounts a registration program such that the processor 31 functions as registration means 311, transmission means 312, and register-side acquisition means 313. The registration program is a kind of application software and is installed on the auxiliary storage device 33. The registration program may be installed on the main memory 32. The method of installing the registration program on the main memory 32 or the auxiliary storage device 33 is not particularly limited. The registration program can be installed on the main memory 32 or the auxiliary storage device 33 by recording a registration program on a removable recording medium or distributing a registration program through communication via a network. The form of the recording medium does not matter as long as the recording medium can store programs and an apparatus can read the programs from the recording medium, like an SD memory card, a USB memory, or the like.

The registration means 311 has a function of receiving an operation input with respect to the keyboard 36, the scanner 37, or the touch panel 38 and registering a commodity to be purchased by a customer. The transmission means 312 has a function of transmitting information related to a transaction of the commodity registered by the registration means 311, via the network 14, to a checkout machine 12, from which a notification indicating that information is receivable has been received. The register-side acquisition means 313 has a function of acquiring information of the customer who purchases the commodity registered by the registration means 311. The information of the customer is the customer segment information set in the setting file 15.

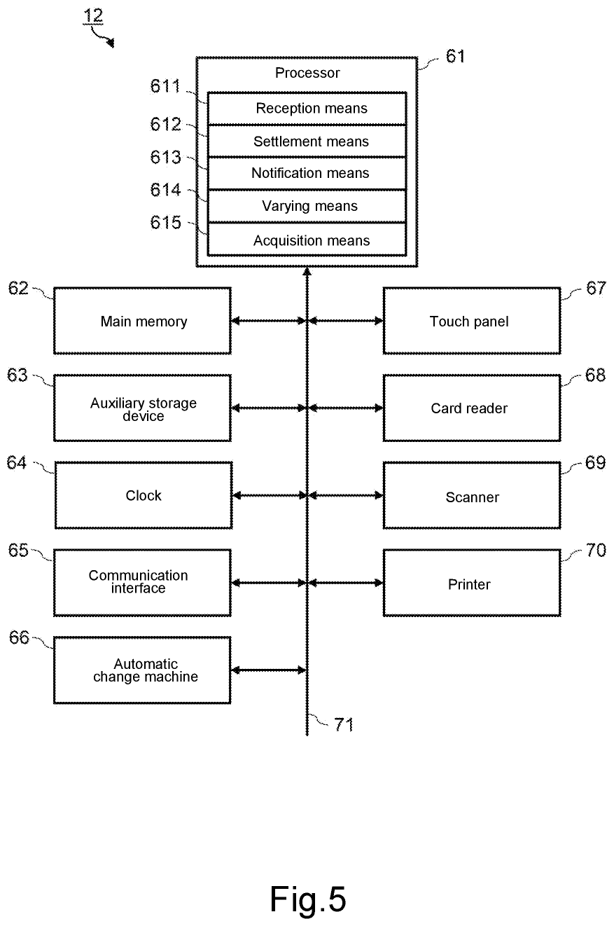

FIG. 5 is a block diagram showing a circuit of a main part of the checkout machine 12. The checkout machine 12 includes a processor 61, a main memory 62, an auxiliary storage device 63, a clock 64, a communication interface 65, an automatic change machine 66, a touch panel 67, a card reader 68, a scanner 69, a printer 70, a system transmission path 71, and the like. The system transmission path 71 includes an address bus, a data bus, a control signal line, and the like. The system transmission path 71 connects the processor 61 and the other units to each other directly or via a signal input/output circuit and transmits data signals to be exchanged therebetween.

The checkout machine 12 connects the processor 61 with the main memory 62, the auxiliary storage device 63, the clock 64, and the communication interface 65 by the system transmission path 71, thus constituting a computer. The checkout machine 12 then connects the devices such as the automatic change machine 66, the touch panel 67, the card reader 68, the scanner 69, and the printer 70 to the computer via the system transmission path 71.

The processor 61 corresponds to the central portion of the computer. The processor 61 controls the units so as to implement various functions as the checkout machine 12 according to the operating system or an application program. The processor 61 is favorably of a multi-core or multithread type capable of performing a plurality of types of processing in parallel. The processor 61 is, for example, a CPU.

The main memory 62 corresponds to a main storage portion of the computer. The main memory 62 includes a nonvolatile memory area and a volatile memory area. The main memory 62 stores the operating system or an application program in the nonvolatile memory area. The main memory 62 may store data, which is necessary for the processor 61 to execute processing for controlling the units, in the nonvolatile or volatile memory area. The processor 61 uses the volatile memory area of the main memory 62 as a work area in which data is appropriately rewritten by the processor 61. The nonvolatile memory area is, for example, a ROM. The volatile memory area is, for example, a RAM.

The auxiliary storage device 63 corresponds to an auxiliary storage portion of the computer. For example, an EEPROM, an HDD, an SSD, or the like can be the auxiliary storage device 63. The auxiliary storage device 63 saves data used by the processor 61 to perform various types of processing, data created in the processing by the processor 61, and the like. The auxiliary storage device 63 may store the application program.

The clock 64 counts date and time. The processor 61 processes the date and time counted by the clock 64 as current date and time.

The communication interface 65 performs data communication with the server 13 or the register 11 connected via the network 14. The communication interface 65 is also capable of performing data communication with another checkout machine 12 connected via the network 14.

The automatic change machine 66 is a device that processes cash. The automatic change machine 66 includes a bill depositing port, a bill dispensing port, a coin depositing port, and a coin dispensing port. The automatic change machine 66 processes bills deposited in the bill depositing port. The automatic change machine 66 dispenses bills as change from the bill dispensing port. The automatic change machine 66 receives and processes coins deposited in the coin depositing port. The automatic change machine 66 dispenses coins as change from the coin dispensing port.

The touch panel 67 is a display device capable of displaying display elements including characters, symbols, images, and the like on the display. Further, the touch panel 67 is also an input device that detects a touched position on the display by a sensor and performs processing on the assumption that a display element at that position is input. The touch panel 67 displays information to the customer as the operator of the checkout machine 12 and receives an operation input by the customer.

The card reader 68 is an input device that reads data recorded on a card medium such as a credit card, an electronic money card, or a rewards card. If the card medium is a magnetic card, the card reader 68 is a magnetic card reader. If the card medium is an IC card, the card reader 68 is an IC card reader. The checkout machine 12 may include either one or both of a magnetic card reader and an IC card reader as the card reader 68. The card reader 68 may be a card reader/writer having a function of writing data to a card.

The scanner 69 is an input device for reading a code symbol such as a bar code or a two-dimensionally code. The scanner 69 may be of a type that reads a code symbol by scanning of laser light or may be of a type that reads a code symbol from an image captured by an imaging device.

The printer 70 is an output device that prints data related to a purchase receipt, a credit card bill, or the like onto receipt paper. The receipt paper on which various types of data are printed by the printer 70 is cut by a cutter and issued from a receipt issuing port. The printer 70 is constituted by, for example, a thermal printer or a dot impact printer.

As the hardware of such a checkout machine 12, for example, an existing self-service POS terminal can be used. Note that the devices connected to the checkout machine 12 are not limited to the automatic change machine 66, the touch panel 67, the card reader 68, the scanner 69, and the printer 70 shown in FIG. 5. It may also be possible to add devices necessary for use application of the checkout machine 12 or omit some devices.

The checkout machine 12 mounts a settlement program such that the processor 61 functions as reception means 611, settlement means 612, notification means 613, varying means 614, and checkout machine-side acquisition means 615. The settlement program is a kind of application software and is installed on the auxiliary storage device 63. The settlement program may be installed on the main memory 62. The method of installing the settlement program on the main memory 62 or the auxiliary storage device 63 is not particularly limited. The settlement program can be installed on the main memory 62 or the auxiliary storage device 63 by recording a settlement program on a removable recording medium or distributing a settlement program through communication via a network. The form of the recording medium does not matter as long as the recording medium can store programs and an apparatus can read the programs from the recording medium, like an SD memory card, a USB memory, or the like.

The reception means 611 has a function of receiving information related to a transaction of a commodity from the register 11 via the communication interface 65. The settlement means 612 has a function of performing settlement of the transaction of the commodity on the basis of the information related to the transaction of the commodity, which has been received by the reception means 611. The notification means 613 has a function of notifying the register 11 of the fact that the information related to the transaction of the commodity is receivable at the time point at which a standby period has elapsed after the settlement processing by the settlement means 612 is finished. The varying means 614 has a function of varying the standby period in accordance with the information of a customer whose transaction has been settled by the settlement means 612. The checkout machine-side acquisition means 615 has a function of acquiring the information of the customer whose transaction has been settled by the settlement means 612. Incidentally, the varying means 614 varies the standby period in accordance with the information of the customer, which is acquired by the checkout machine-side acquisition means 615.

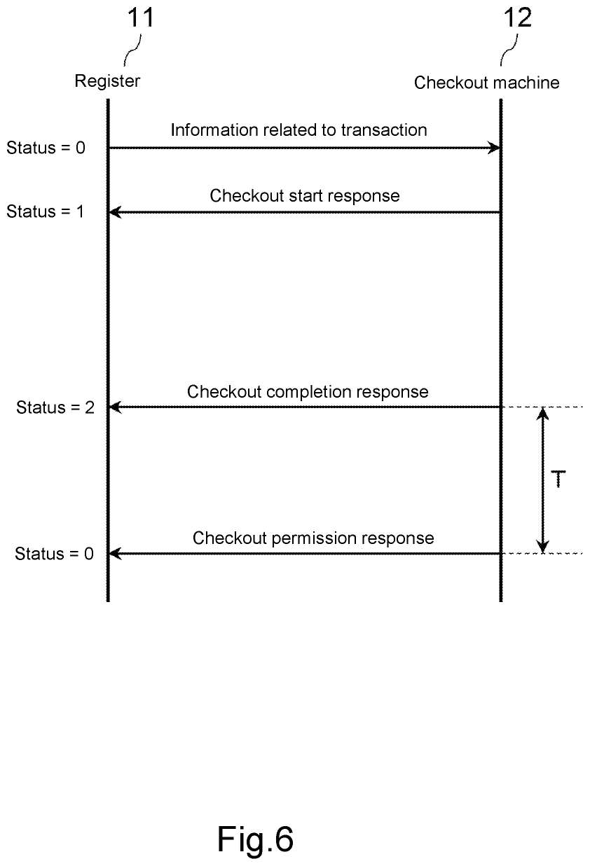

FIG. 6 is a schematic diagram showing a sequence of information exchanged between the register 11 and the checkout machine 12 and a transition of a status indicating a state of the checkout machine 12. The register 11 transmits information related to a transaction of a registered commodity to a checkout machine 12 capable of receiving the information related to the transaction, that is, a checkout machine 12 having a status “0”. When receiving the information related to the transaction of the commodity, the checkout machine 12 transmits a data signal of a checkout start response to the register 11. Further, the checkout machine 12 executes settlement processing on the basis of the information related to the transaction of the commodity. The checkout machine 12, which has finished the settlement processing, transmits a data signal of a checkout completion response to the register 11.

When receiving the data signal of the checkout start response from the checkout machine 12, the register 11 changes the value of the status indicating the state of the checkout machine 12 from “0” (value indicating a state capable of receiving information) to “1” (value indicating a state in which the settlement processing is being performed). Further, when receiving the data signal of the checkout completion response from the checkout machine 12, the register 11 changes the value of the status indicating the state of the checkout machine 12 from “1” to “2” (value indicating a standby state after completion of the settlement).

Meanwhile, the checkout machine 12, which has transmitted the data signal of the checkout completion response, waits until a predetermined standby period T elapses. After the standby period T elapses, the checkout machine 12 transmits a data signal of a checkout permission response to the register 11. The register 11, which has received the data signal of the checkout permission response, changes the value of the status indicating the state of the checkout machine 12 from “2” to “0”. In such a manner, the value of the status transitions in the order of “0”, “2”, and “0”. The checkout machine 12 whose value of the status has changed to “0” can be a destination, to which the information related to the transaction is to be transmitted, in the register 11.

Note that, depending on circumstances, a customer cancels the checkout before the settlement is completed. In such a case, the data signal of the checkout permission response is transmitted from the checkout machine 12 to the register 11, and the data signal of the checkout completion response is not transmitted thereto. Therefore, the value of the status transitions in the order of “0”, “1”, and “0”.

### DESCRIPTION ON OPERATION

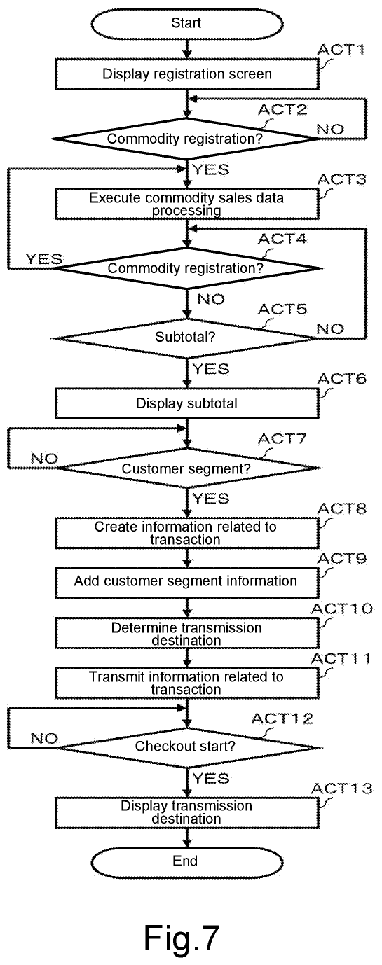

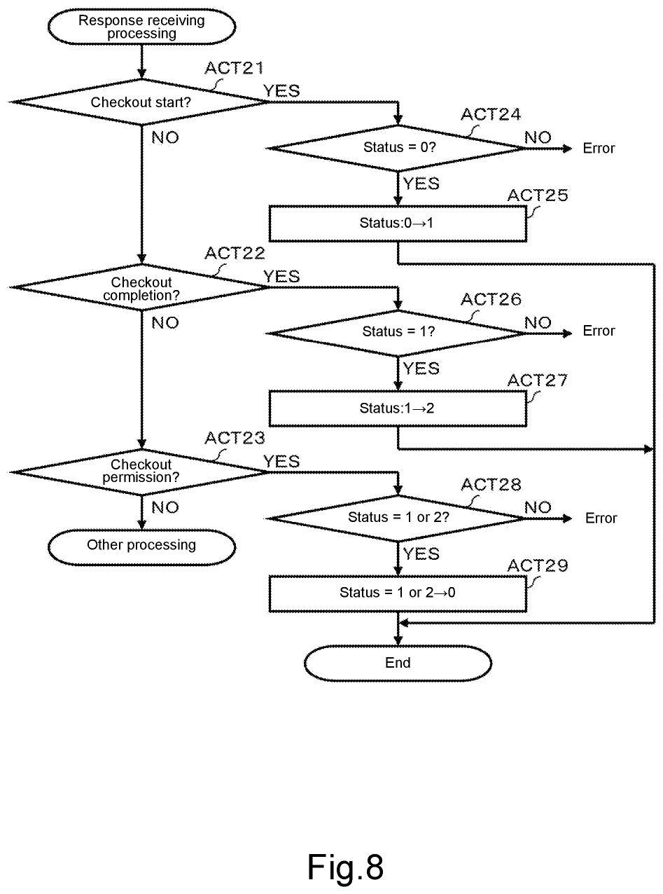

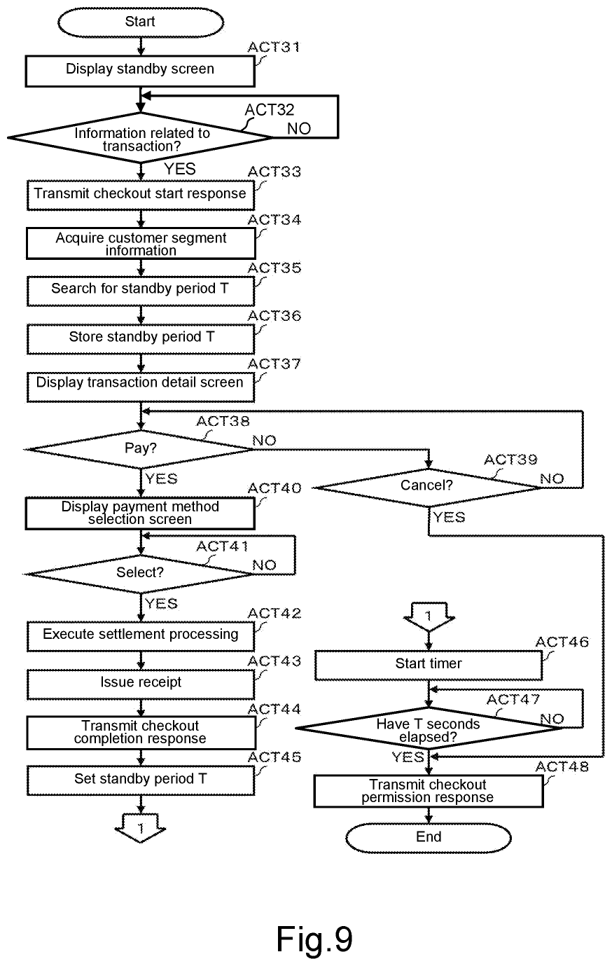

FIGS. 7 and 8 are flowcharts showing information processing executed by the processor 31 of the register 11 according to the registration program. FIG. 9 is a flowchart showing information processing executed by the processor 61 of the checkout machine 12 according to the settlement program. Hereinafter, a main operation of the checkout system 100 will be described with reference to the drawings. Note that the procedures and contents of the information processing to be described later are examples. The procedures and contents are not particularly limited as long as similar effects can be obtained.

First, the operation of the register 11 will be described. The processor 31 of the register 11 in an idle state starts information processing shown in FIG. 7. In ACT1, the processor 31 first causes the touch panel 38 to display a registration screen. The registration screen is a screen in which a detail region and a total region are disposed. The detail region is a region for displaying a commodity name, the number of pieces, a unit price, and the amount of a commodity to be purchased in a list form in the order of serial numbers. Note that the items displayed in the detail region are not limited to the commodity name, the number of pieces, the unit price, and the amount. Other items may be added, or any item, for example, the amount may be omitted. The total region is a region for displaying the total number (pieces) and the total amount (yen) of the commodities displayed in the detail region. Note that the items displayed in the total region are not limited to the total number of pieces and the total amount. Other items may be added, or any item, for example, the total number of pieces may be omitted.

The processing of the processor 31, which has caused the touch panel 38 to display the registration screen, proceeds to ACT2. In ACT2, the processor 31 waits for a commodity registration. Most commodities are each provided with a bar code representing a commodity code, which is identification information of that commodity. In this regard, when the store clerk 21 is asked to perform checkout for a commodity to be purchased by the customer 22, the store clerk 21 operates the scanner 37 to read the bar code provided to the commodity to be purchased. The bar code is read with the scanner 37, and thus the commodity code of the commodity to be purchased is input to the register 11. Meanwhile, some commodities such as perishable food are not provided with bar codes in some cases. If a commodity to be purchased is not provided with a bar code, the store clerk 21 operates a soft key corresponding to the commodity to be purchased, which is a so-called commodity key, from a soft key group for commodities without bar codes that is displayed on a part of the registration screen. When the commodity key is operated, the commodity code of the commodity to be purchased corresponding to that commodity key is input to the register 11. In such a manner, when the commodity code of the commodity to be purchased is input to the register 11, the processor 31 determines that the commodity registration has been performed.

In ACT2, if the processor 31 determines that the commodity registration has been performed (ACT2: YES), the processing of the processor 31 proceeds to ACT3. In ACT3, the processor 31 executes commodity sales data processing. Specifically, the processor 31 searches for a commodity file and acquires commodity data such as a commodity name and a unit price of the commodity identified with the commodity code input via the scanner 37 or the touch panel 38. The processor 31 then saves commodity sales data including the items of a commodity code, a commodity name, a unit price, the number of sold commodities, the sales amount, and the like in a transition memory. The transition memory is a part of the volatile memory area in the main memory 32.

The processor 31, which has finished the commodity sales data processing, waits for the next commodity registration in ACT4, and waits for an instruction of subtotal output in ACT5. The subtotal output is instructed when a subtotal key is operated. The subtotal key may be a hard key disposed in the keyboard 36 or may be a soft key disposed on the registration screen.

If there is another commodity to be purchased, the store clerk 21 performs the registration operation as described above for that commodity to be purchased. When the registration operation for all the commodities to be purchased is finished, the store clerk 21 operates the subtotal key.

In the waiting state in ACT4 and ACT5, if the commodity registration is detected before the subtotal output is instructed (ACT4: YES), the processing of the processor 31 returns from ACT4 to ACT3. The processor 31 then executes the commodity sales data processing again. Meanwhile, if the subtotal output is instructed by the operation of the subtotal key (ACT5: YES), the processing of the processor 31 proceeds from ACT5 to ACT6. In ACT6, the processor 31 causes the touch panel 38 to display a subtotal amount. The subtotal amount is the amount obtained by combining the sales amounts of the commodity sales data, which have been saved in the transition memory by the commodity sales data processing.

The store clerk 21 confirms the subtotal amount and then determines a customer segment suitable for that customer on the basis of the appearance or the like of the customer. The store clerk 21 then operates one of the customer segment keys 361 to 364, to which that customer segment is assigned. If the store clerk 21 determines that the customer is an adult, the store clerk 21 operates the adult key 361. If the store clerk 21 determines that the customer is a child, the store clerk 21 operates the child key 362. If the store clerk 21 determines that the customer is an elderly person, the store clerk 21 operates the elderly person key 363. If the store clerk 21 determines that the customer is a disabled person, the store clerk 21 operates the disabled person key 364.

The processing of the processor 31, which has caused the touch panel 38 to display the subtotal amount, proceeds to ACTT. In ACT7, the processor 31 waits until the customer segment keys 361 to 364 are operated. If any one of the customer segment keys 361 to 364 is operated (ACT7: YES), the processing of the processor 31 proceeds from ACT7 to ACT8. In ACT8, the processor 31 creates information related to the transaction. For example, the processor 31 creates a transaction information file in which the commodity sales data of the commodity to be purchased, which is saved in the transition memory, and transaction identification data such as a transaction number, a transaction date and time, and a register ID are described. Note that the information related to the transaction is not limited to the above-mentioned transaction information file. In short, the information related to the transaction only needs to be information, with which a transaction of a commodity can be settled in the checkout machine 12.

The processing of the processor 31, which has created the transaction information file, proceeds to ACT9. In ACT9, the processor 31 adds customer segment information to the transaction information file. In other words, if the adult key 361 is operated in ACT7, the processor 31 adds the customer segment information “adult” to the transaction information file. If the child key 362 is operated, the processor 31 adds the customer segment information “child” to the transaction information file. If the elderly person key 363 is operated, the processor 31 adds the customer segment information “elderly person” to the transaction information file. If the disabled person key 364 is operated, the processor 31 adds the customer segment information “disabled person” to the transaction information file.

The processing of the processor 31, which has added the customer segment information to the transaction information file, proceeds to ACT10. In ACT10, the processor 31 refers to the state table 321 to determine a checkout machine 12 that is to be a destination to which the information related to the transaction is to be transmitted. Specifically, the processor 31 selects a checkout machine ID having a value of the status “0” from the state table 321. At that time, if two or more checkout machines ID are selected, the processor 31 selects any one of the checkout machines ID according to a predetermined rule. For example, the processor 31 selects a checkout machine ID having the longest elapse time after lastly selected. The processor 31 determines a checkout machine 12 having the selected checkout machine ID to be a destination to which the information related to the transaction is to be transmitted.

The processing of the processor 31, which has determined the destination to which the information related to the transaction is to be transmitted, proceeds to ACT11. In ACT11, the processor 31 controls the communication interface 35 to transmit the information related to the transaction, that is, the transaction information file created in ACT8 and provided with the customer segment information in ACT9, to the checkout machine 12 serving as a transmission destination. Through such control, the transaction information file is transmitted via the network 14 and received by the checkout machine 12 as a transmission destination. At that time, as described with reference to FIG. 6, the data signal of the checkout start response is transmitted to the register 11 from the checkout machine 12 that has received the transaction information file.

In ACT12, the processor 31, which has controlled the transmission of the transaction information file in ACT11, waits for the data signal of the checkout start response. If the data signal of the checkout start response is received via the communication interface 35 (ACT12: YES), the processing of the processor 31 proceeds from ACT12 to ACT13. In ACT13, the processor 31 causes the touch panel 38 to display information, with which the checkout machine 12 serving as a transmission destination of the transaction information file can be specified. For example, the processor 31 causes the touch panel 38 to display a guidance indicating that “the transmission destination of the transaction information is a checkout machine with a register number N.”, together with a soft key for confirmation, which is a so-called confirmation key. After confirming such a guidance, the store clerk 21 instructs the customer 22 to perform checkout in the checkout machine 12 having the register number N, and also operates the confirmation key.

The processor 31, which has finished the processing of ACT13, ends the information processing shown in FIG. 7. In response to the operation on the confirmation key, the processor 31 returns to the idle state. In other words, the processor 31 causes the touch panel 38 to display a registration screen. Therefore, when the store clerk is asked to perform checkout for a commodity to be purchased by the next customer, the store clerk can start a registration operation of that commodity to be purchased.

Here, the processor 31 of the register 11 implements the function as the registration means 311 by the processing from ACT2 to ACT4. The processor 31 implements the function as the transmission means 312 by the processing of ACT10 and ACT11. The processor 31 implements the function as the register-side acquisition means 313 by the processing of ACT7 and ACT9.

As described above, in the register 11, the information related to the transaction is created for each customer. The information related to the transaction, to which the customer segment information based on the determination by a store clerk is added, is transmitted to the checkout machine 12. Here, a checkout machine 12 that is to be a transmission destination of the information related to the transaction is a checkout machine 12 whose status managed by the state table 321 is “0”. The status of the state table 321 is managed when the processor 31 of the register 11 performs response receiving processing. In this regard, the response receiving processing will now be described specifically.

FIG. 8 is a flowchart showing the response receiving processing executed by the processor 31 of the register 11. The processor 31 starts the response receiving processing each time a response data signal is received from the checkout machine 12.

First, in ACT21, the processor 31 confirms whether or not the response data signal from the checkout machine 12 is a data signal of a checkout start response. If the response data signal is not a data signal of a checkout start response (ACT21: NO), the processing of the processor 31 proceeds to ACT22. In ACT22, the processor 31 confirms whether or not the response data signal is a data signal of a checkout completion response. If the response data signal is not a data signal of a checkout completion response (ACT22: NO), the processing of the processor 31 proceeds to ACT23. In ACT23, the processor 31 confirms whether or not the response data signal from the checkout machine 12 is a data signal of a checkout permission response. If the response data signal is not a data signal of a checkout permission response (ACT23: NO), the processor 31 executes other processing. Other processing is not the gist of this embodiment, and thus description thereof will be omitted.

If the response data signal is a data signal of a checkout start response (ACT21: YES), the processing of the processor 31 proceeds from ACT21 to ACT24. In ACT24, the processor 31 confirms that the value of the status indicating the state of the checkout machine 12 serving as a transmission source of the data signal of the checkout start response is “0” (value indicating a state capable of receiving the information related to the transaction). Hereinafter, the status indicating the state of the checkout machine 12 serving as a transmission source of the data signal of the checkout start response will be referred to as a transmission source status. If the value of the transmission source status is “0” (ACT24: YES), the processing of the processor 31 proceeds from ACT24 to ACT25. In ACT25, the processor 31 changes the value of the transmission source status from “0” to “1” (value indicating a state in which the checkout machine 12 is performing settlement processing).

If the response data signal from the checkout machine 12 is a data signal of a checkout completion response (ACT22: YES), the processing of the processor 31 proceeds from ACT22 to ACT26. In ACT26, the processor 31 confirms that the value of the transmission source status is “1” (value indicating a state in which the checkout machine 12 is performing settlement processing). If the value of the transmission source status is “1”, the processing of the processor 31 proceeds from ACT26 to ACT27. In ACT27, the processor 31 changes the value of the transmission source status from “1” to “2” (value indicating a standby state after completion of the settlement).

If the response data signal from the checkout machine 12 is a data signal of a checkout permission response (ACT23: YES), the processing of the processor 31 proceeds from ACT23 to ACT28. In ACT28, the processor 31 confirms that the value of the transmission source status is “1” or “2”. If the value of the transmission source status is “1” or “2” (ACT28: YES), the processing of the processor 31 proceeds from ACT28 to ACT29. In ACT29, the processor 31 changes the value of the transmission source status from “1” or “2” to “0”.

Note that, if the value of the transmission source status is other than “0” in ACT24 (ACT24: NO), other than “1” in ACT26 (ACT26: NO), or other than “1” or “2” in ACT28 (ACT28: NO), a system error is occurring. The processor 31 announces a system error. For example, the processor 31 causes the touch panel 38 to display an alert message indicating that a system error is occurring.

As described above, the processor 31 executes the response receiving processing each time the processor 31 receives a response data signal from the checkout machine 12, and thus the value of the status of the checkout machine 12 in the state connected to the register 11 transitions in the order of “0”, “1”, “2”, and “0” or in the order of “0”, “1”, and “0”. The register 11 determines the checkout machine 12 having the value of the status “0” to be a transmission destination of the information related to the transaction.

Next, the operation of the checkout machine 12 will be described. The processor 61 of the checkout machine 12 in an idle state, that is, in a state capable of receiving the information related to the transaction, starts the information processing shown in FIG. 9. First, in ACT31, the processor 61 causes the touch panel 67 to display a standby screen. The standby screen is a screen displaying information indicating that the checkout machine 12 waits for checkout by a customer, for example, a text such as “Welcome”.

The processing of the processor 61, which has caused the touch panel 67 to display the standby screen, proceeds to ACT32. In ACT32, the processor 61 waits for the information related to the transaction. If the information related to the transaction, that is, the transaction information file is received via the communication interface 65 (ACT32: YES), the processing of the processor 61 proceeds from ACT32 to ACT33. In ACT33, the processor 61 transmits a data signal of a checkout start response to the register 11. Thus, the register 11 changes the status of that checkout machine 12 from “0” to “1”.

Further, in ACT34, the processor 61 acquires customer segment information from the transaction information file. In ACT35, the processor 61 accesses the server 13 to search for a standby period T that is set in the setting file 15 in association with the customer segment information. In ACT36, the processor 61 stores the standby period T, which has been searched for and retrieved, in the main memory 62.

In ACT37, the processor 61 switches the screen of the touch panel 67 to a transaction detail screen. The transaction detail screen is a screen in which a detail region and a total region are disposed. In the detail region, a commodity name, the number of pieces, a unit price, and the amount of a commodity to be purchased, which are stored in the transaction information file, are displayed in a list form. In the total region, the total number (pieces) and the total amount (yen) of the commodities displayed in the detail region are displayed. Further, in the transaction detail screen, each soft key of a payment key and a cancel key is displayed. A customer who confirms the transaction detail screen and makes payment operates the payment key. A customer who cancels payment operates the cancel key.

The processing of the processor 61, which has caused the touch panel 67 to display the transaction detail screen, proceeds to ACT38. The processor 61 waits until the payment key is operated in ACT38 or the cancel key is operated in ACT39. In the waiting state in ACT38 and ACT39, if the processor 61 detects that the payment key is operated (ACT38: YES), the processing of the processor 61 proceeds from ACT38 to ACT40. In ACT40, the processor 61 switches the screen of the touch panel 67 to a payment method selection screen. In the payment method selection screen, soft keys of a cash key, a credit key, an electronic money key, and a code settlement key are displayed. A customer who pays in cash operates the cash key and deposits cash in the automatic change machine. A customer who pays by a credit card operates the credit key and causes the card reader 68 to read the data of the credit card. A customer who pays by electronic money operates the electronic money key and causes the card reader to read the data of an electronic money card. A customer who pays by code settlement operates the code settlement key and causes the scanner 69 to read a settlement code displayed on a smartphone.

The processing of the processor 61, which has caused the touch panel 67 to display the payment method selection screen, proceeds to ACT41. In ACT41, the processor 61 waits until any payment method is selected. If the cash key, the credit key, the electronic money key, or the code settlement key is operated (ACT41: YES), the processing of the processor 61 proceeds to ACT42. In ACT42, the processor 61 executes settlement processing. For example, if the cash key is operated, the processor 61 executes cash settlement processing on the basis of the cash deposited in the automatic change machine 66. For example, if the credit key is operated, the processor 61 executes credit settlement processing on the basis of the data of the credit card, which is read by the card reader 68. For example, if the electronic money key is operated, the processor 61 executes electronic money settlement processing on the basis of the data of the electronic money card, which is read by the card reader 68. For example, if the code settlement key is operated, the processor 61 executes code settlement processing on the basis of the settlement code read by the scanner 69. The settlement processing described above is well-known processing, and thus detailed description thereof will be omitted.

If the processor 61 finishes the settlement processing, the processing of the processor 61 proceeds to ACT43. In ACT43, the processor 61 controls the printer 70 to issue a receipt. After a receipt is issued, in ACT44, the processor 61 transmits a data signal of a checkout completion response to the register 11. Thus, the register 11 changes the status of the checkout machine 12 from “1” (value indicating a state in which the settlement processing is being performed) to “2” (value indicating a standby state after completion of the settlement).

In ACT45, the processor 61 sets the standby period T stored in the main memory 62, as a timeout period, for a timer incorporated into the processor 61. In ACT46, the processor 61 starts the timer. In ACT47, the processor 61 wait for timeout of the timer. If the counted time of the timer reaches the standby period T to cause timeout (ACT47: YES), the processing of the processor 61 proceeds from ACT47 to ACT48. In ACT48, the processor 61 transmits a data signal of a checkout permission response to the register 11. Thus, the register 11 changes the status of the checkout machine 12 from “2” to “0”.

Note that in the waiting state in ACT38 and ACT39, if the cancel key is operated (ACT39: YES), the processing of the processor 61 proceeds from ACT39 to ACT48. In ACT48, the processor 61 transmits the data signal of the checkout permission response to the register 11. Thus, the register 11 changes the status of the checkout machine 12 from “1” to “0” (value indicating a state capable of receiving the information related to the transaction).

After finishing the processing in ACT48, the processor 61 ends the information processing shown in FIG. 9. The processor 61 enters the idle state. Therefore, the screen of the touch panel 67 is switched to a standby screen, so that the next customer can start the settlement of a transaction.

Here, the processor 61 of the checkout machine 12 implements the function as the reception means 611 by the processing of ACT32 and ACT33. The processor 61 implements the function as the settlement means 612 by the processing from ACT38 to ACT44. The processor 61 implements the function as the notification means 613 by the processing of ACT48. The processor 61 implements the function as the varying means 614 by the processing from ACT45 to ACT47. The processor 61 implements the function as the checkout machine-side acquisition means 615 by the processing of ACT34.

As described above in detail, in the first embodiment, the store clerk who operates the register 11 determines the customer segment suitable for the customer and operates a key corresponding to the customer segment among the customer segment keys 361 to 364. Through such an operation, the standby period T, which elapses after the customer finishes settlement of a transaction in the checkout machine 12 and before a data signal of a checkout permission response is transmitted from the checkout machine 12 to the register 11, is varied. In other words, a timing for notifying the register 11 of the fact that information related to a transaction is receivable is varied depending on a customer who finishes settlement. Specifically, if a customer determined as “adult” by the store clerk finishes the settlement, in 10 seconds later, the data signal of the checkout permission response is transmitted from the checkout machine 12 to the register 11. If a customer determined as “child” by the store clerk finishes the settlement, in 20 seconds later, the data signal of the checkout permission response is transmitted from the checkout machine 12 to the register 11. If a customer determined as “elderly person” or “disabled person” by the store clerk finishes the settlement, in 30 seconds later, the data signal of the checkout permission response is transmitted from the checkout machine 12 to the register 11.

In general, an able-bodied adult who does not belong to an elderly person is estimated to move away from the front of the checkout machine 12 in at most 10 seconds. Further, a child of an elementary age or younger is estimated to move away from the front of the checkout machine 12 in at most 20 seconds. Meanwhile, an elderly person or disabled person is estimated to move away from the front of the checkout machine 12 in at most 30 seconds, though they may be slow in performing processing or fail to taking a prompt action. Therefore, according to the first embodiment, at the time point at which the data signal of the checkout permission response is transmitted from the checkout machine 12 to the register 11, the customer has moved away from the front of the checkout machine 12 regardless of the customer segments of adult, child, and elderly person or disabled person. Hence, the following case is very difficult to occur with a high probability: a previous customer is located near the checkout machine 12 and thus hinders the next customer from operating the checkout machine 12 and performing settlement of a transaction. Further, information necessary for settlement of a transaction with the next customer is not displayed to the previous customer, and thus there is no risk that confusion between the previous customer and the next customer is caused. In such a manner, according to this embodiment, it is possible to provide a checkout machine 12 and its program, which are capable of preventing unnecessary confusion from being caused, and a checkout system 10 including such a checkout machine 12.

### Second Embodiment

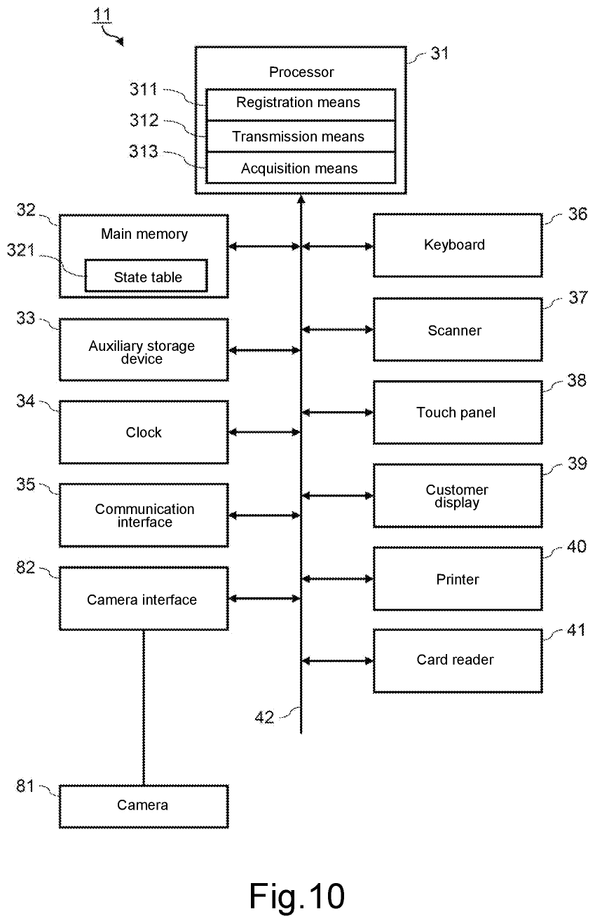

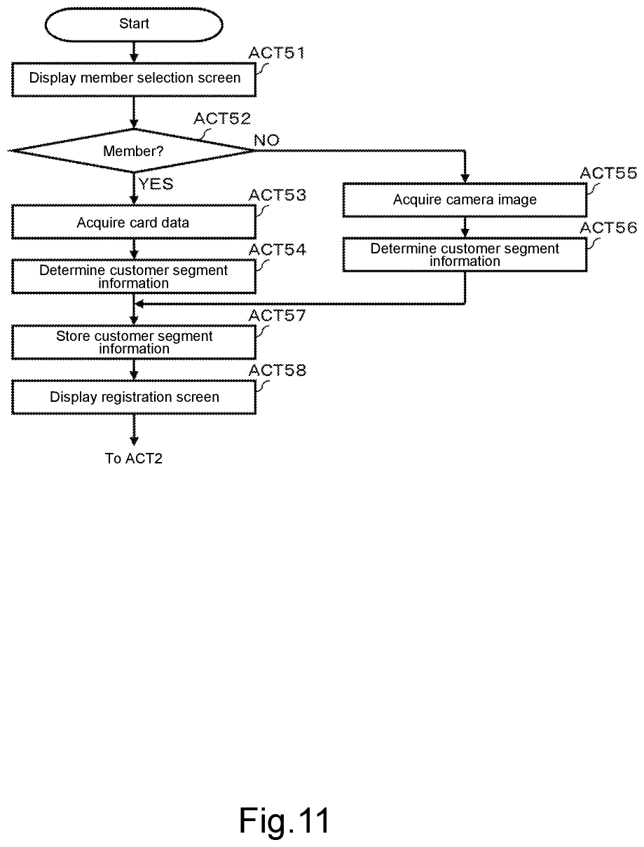

Next, a second embodiment will be described with reference to FIGS. 10 and 11 in addition to FIGS. 1 to 9. In the first embodiment, the case where a store clerk who operates the register 11 observes a customer, determines a customer segment suitable for the customer, and operates one of the customer segment keys 361 to 364 corresponding to the customer segment for input has been described as an example. In the second embodiment, a case where the register 11 automatically determines a customer segment of a customer will be described as an example.

In this second embodiment as well, the configuration of the checkout system 10 is similar to that of the first embodiment. Further, the configuration of the checkout machine 12 and the operation thereof are also similar to those of the first embodiment. Therefore, FIGS. 1, 2, 5, 6, and 9 apply to the second embodiment as they are. Further, the register 11 includes the state table 321, and the processor 31 executes the response receiving processing similarly to the first embodiment, and thus FIGS. 4 and 8 also apply to the second embodiment as they are.

FIG. 10 is a block diagram showing a circuit of a main part of the register 11 in the second embodiment. Note that portions common to those of the register 11 according to the first embodiment shown in FIG. 3 will be denoted by the same reference symbols, and detailed description thereof will be omitted. The register 11 includes a camera 81 and a camera interface 82, in addition to a processor 31, a main memory 32, an auxiliary storage device 33, a clock 34, a communication interface 35, a keyboard 36, a scanner 37, a touch panel 38, a customer display 39, a printer 40, a card reader 41, and a system transmission path 42. The camera interface 82 is connected to the system transmission path 42.

The camera 81 is a video camera mounted to a position at which a customer whose commodity to be purchased is registered in the register 11 can be imaged. The image data captured by the camera 81 is supplied to the processor 31 via the camera interface 82. The processor 31 has a function of processing the image data and determining customer segment information such as “adult”, “child”, “elderly person”, or “disabled person” from a feature amount of a person appearing in the image.

Further, the card reader 41 is capable of reading data of a membership card owned by a customer. In the membership card, identification information on the age of the customer owning the membership card and on whether or not the customer is a disabled person is recorded. The card data read by the card reader 41 is supplied to the processor 31. The processor 31 has a function of determining the customer segment information such as “adult”, “child”, “elderly person”, or “disabled person” from the card data.

Note that the customer segment keys 361 to 364 disposed in the keyboard 36 can be omitted in the second embodiment.

FIG. 11 is a flowchart showing information processing executed by the processor 31 according to a registration program. The processor 31 of the register 11 in an idle state starts the information processing shown in FIG. 11. In ACT51, the processor 31 first causes the touch panel 38 to display a member selection screen. On the member selection screen, soft keys of a member key and a non-member key are disposed. If a customer who wants to perform checkout is a non-member, a store clerk operates the non-member key. To the contrary, if the customer is a member, the store clerk operates the member key to cause the card reader 41 to read the data of the membership card presented by the member.

The processing of the processor 31, which has caused the touch panel 38 to display the member selection screen, proceeds to ACT52. In ACT52, the processor 31 waits until the member key is operated for input or the non-member key is operated for input. If the member key is operated for input (ACT52: YES), the processing of the processor 31 proceeds from ACT52 to ACT53. In ACT53, the processor 31 acquires the card data read by the card reader 41. In ACT54, the processor 31 determines customer segment information on the basis of the card data. For example, if the card data includes data indicating a disabled person, the processor 31 determines the customer segment information to be “disabled person”. If the card data includes data indicating a disabled person, the processor 31 acquires the age from the card data. For example, if the age is 12 years or younger, the processor 31 determines the customer segment information to be “child”. For example, if the age is 70 years or older, the processor 31 determines the customer segment information to be “elderly person”. In other cases, the processor 31 determines the customer segment information to be “adult”.

Meanwhile, in the waiting state of ACT52, if the non-member key is input (ACT52: NO), the processing of the processor 31 proceeds from ACT52 to ACT55. In ACT55, the processor 31 acquires image data captured by the camera 81. In ACT56, the processor 31 determines the customer segment information such as “adult”, “child”, “elderly person”, or “disabled person” from a feature amount of a person appearing in that image.

In ACT54 or ACT56, if the processor 31 determines the customer segment information, the processing of the processor 31 proceeds to ACT57. In ACT57, the processor 31 stores the customer segment information in the main memory 32. Further, in ACT58, the processor 31 switches the screen of the touch panel 38 from the member selection screen to a registration screen. The registration screen is similar to the registration screen displayed in the processing of ACT1 in the first embodiment. Hereinafter, the processor 31 executes the processing from ACT2 to ACT13 shown in FIG. 7 similarly to the first embodiment. Note that the customer segment information to be added to the transaction information file in ACT9 is the customer segment information stored in the ACT57.

Here, the processor 31 implements the function as the register-side acquisition means 313 by the processing of ACT53 and ACT54 or the processing of ACT55 and ACT56.

Also in the second embodiment described above, similarly to the first embodiment, a timing at which the checkout machine 12 that has finished the settlement processing notifies the register 11 of the fact that information related to a transaction is receivable, that is, a timing at which a data signal of a checkout permission response is output, can be varied depending on a customer who has finished settlement. As a result, it is possible to prevent the customer from being unnecessarily confused.

Additionally, in the second embodiment, the store clerk does not need to determine the customer segment. Therefore, a burden on the store clerk can be reduced. Besides, regarding the member, the customer segment is determined on the basis of the data of the membership card, which is read by the card reader 41 of the register 11. Therefore, the customer segment can be reliably specified in the register 11. Further, since the technology of specifying the gender and age of a customer from an image captured by the camera 81 is highly reliable, for the non-member as well, it is possible to determine the customer segment equivalently to the determination on appearance by the store clerk 21.

### Third Embodiment

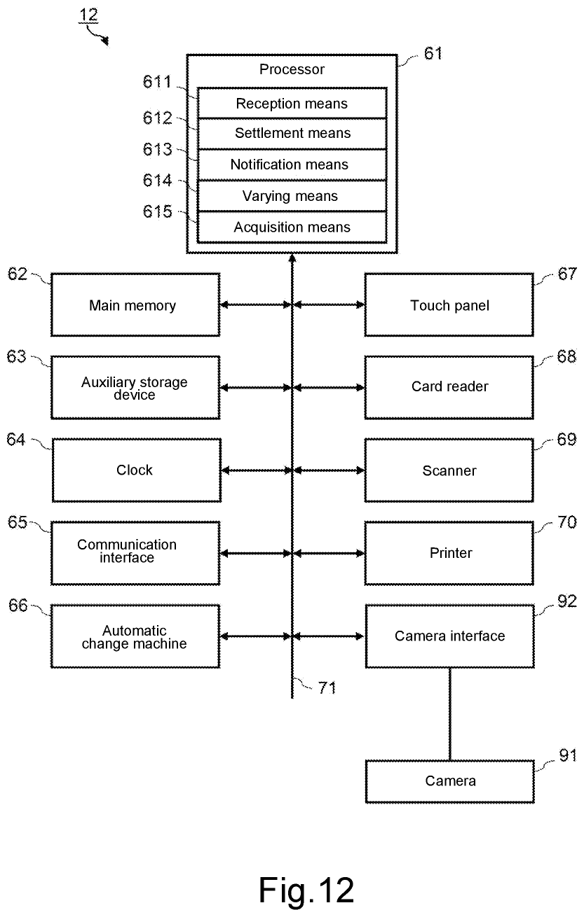

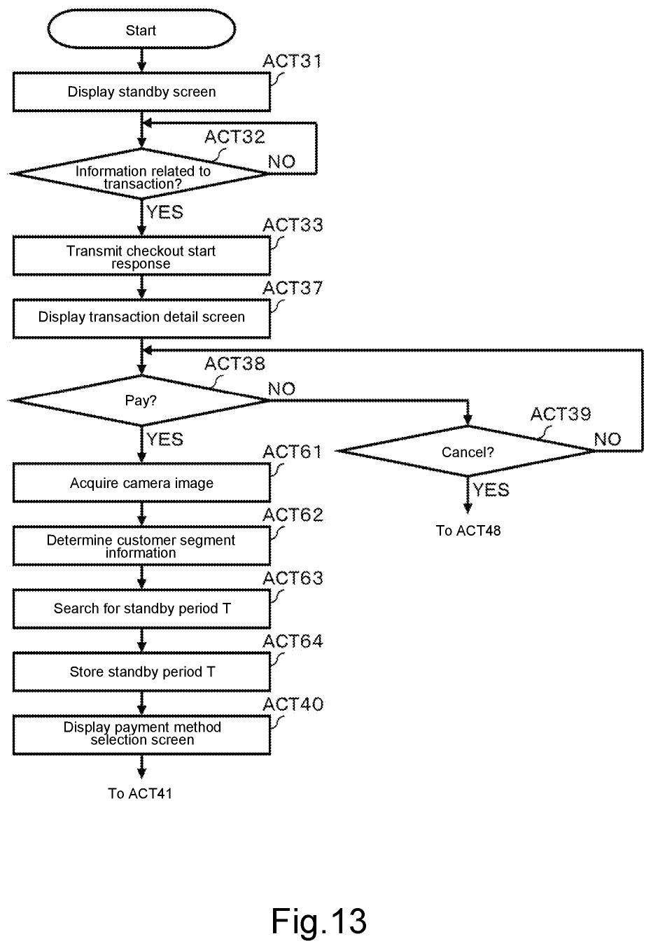

Next, a third embodiment will be described with reference to FIGS. 12 and 13 in addition to FIGS. 1 to 9. In the second embodiment, the case where the register 11 includes the camera 81, and a customer segment of a customer is determined on the basis of an image captured by the camera 81 has been described as an example. In the third embodiment, a case where a customer segment of a customer is determined on the basis of an image captured by a camera 91 will be described as an example.

In this third embodiment as well, the configuration of the checkout system 10 is similar to that of the first embodiment. The configuration of the register 11 is similar to that of the first embodiment, except that the customer segment keys 361 to 364 are omitted from the keyboard 36. Further, the procedure of the information processing executed by the processor 31 of the register 11 according to the registration program is the procedure excluding the processing of ACT9 in FIG. 7. Further, the response receiving processing is similar to that of the first embodiment. Therefore, FIGS. 1, 2, 3, 4, 6, 7, and 8 apply to the third embodiment as they are.

FIG. 12 is a block diagram showing a circuit of a main part of a checkout machine 12 in the third embodiment. Note that portions common to those of the checkout machine 12 according to the first embodiment shown in FIG. 5 will be denoted by the same reference symbols, and detailed description thereof will be omitted. The checkout machine 12 includes a camera 91 and a camera interface 92 in addition to a processor 61, a main memory 62, an auxiliary storage device 63, a clock 64, a communication interface 65, an automatic change machine 66, a touch panel 67, a card reader 68, a scanner 69, a printer 70, and a system transmission path 71. The camera interface 92 is connected to the system transmission path 71.

The camera 91 is a video camera mounted to a position at which a customer who performs a self-checkout operation in the checkout machine 12 can be imaged. The image data captured by the camera 91 is supplied to the processor 61 via the camera interface 92. The processor 61 has a function of processing the image data and determining customer segment information such as “adult”, “child”, “elderly person”, or “disabled person” from a feature amount of a person appearing in the image.

FIG. 13 is a flowchart showing information processing executed by the processor 61 according to a settlement program. Note that portions at which the same processing as the processing of the first embodiment shown in FIG. 9 is executed are denoted by the same reference symbols shown in FIG. 9. In other words, in ACT31, the processor 61 in a state capable of receiving information related to a transaction causes the touch panel 67 to display a standby screen. In ACT32, the processor 61 waits for information related to a transaction. If information related to a transaction, that is, a transaction information file is received via the communication interface (ACT32: YES), in ACT33, the processor 61 transmits a data signal of a checkout start response to the register 11. Note that, in the register 11, the information processing executed by the processor 31 omits the processing of ACT9 in FIG. 7, and thus the customer segment information is not added to the transaction information file. Therefore, the processor 61 does not execute the processing from ACT34 to ACT36 executed in the first embodiment.

In ACT37, the processor 61 switches the screen of the touch panel 67 to a transaction detail screen. The processor 61 waits until a payment key is operated in ACT38 or a cancel key is operated in ACT39. In the waiting state in ACT38 and ACT39, if the cancel key is input (ACT39: YES), the processing of the processor 61 proceeds from ACT39 to ACT48 shown in FIG. 9. In other words, the processor 61 transmits a data signal of a checkout permission response to the register 11.

In the waiting state in ACT38 and ACT39, if the payment key is input (ACT38: YES), the processing of the processor 61 proceeds from ACT38 to ACT61. In ACT61, the processor 61 acquires image data captured by the camera 91. In ACT62, the processor 61 determines customer segment information such as “adult”, “child”, “elderly person”, or “disabled person” from a feature amount of a person appearing in that image.

The processing of the processor 61, which has determined the customer segment information, proceeds to ACT63. In ACT63, the processor 61 accesses the server 13 to search for a standby period T that is set in a setting file 15 in association with the customer segment information. In ACT64, the processor 61 stores the standby period T, which has been searched for and retrieved, in the main memory 62.

The processing of the processor 61, which has stored the standby period T, proceeds to ACT40. In ACT40, the processor 61 switches the screen of the touch panel 67 to a payment method selection screen. Hereinafter, the processor 61 executes the processing from ACT41 to ACT48 shown in FIG. 9, similarly to the first embodiment.

Here, the processor 61 implements the function as checkout machine-side acquisition means 615 by the processing of ACT61 and ACT62. Also in the third embodiment described above, similarly to the first embodiment, a timing at which the checkout machine 12 that has finished the settlement processing notifies the register 11 of the fact that information related to a transaction is receivable can be varied depending on a customer who has finished settlement. As a result, it is possible to prevent the customer from being unnecessarily confused.

Besides, according to the third embodiment, it is not necessary to add the customer segment information to the information related to the transaction transmitted from the register 11 to the checkout machine 12. Therefore, communication efficiency between the register 11 and the checkout machine 12 can be enhanced. Further, for example, there is a case where, in registering commodities to be purchased by customers of a parent and a child, the parent stands near the register 11, whereas the child performs checkout in the checkout machine 12. In such a case, a timing for notifying the register 11 of the fact that information related to a transaction is receivable is a timing of the customer segment information “child”. This makes it possible to prevent a situation in which information related to a transaction of the next customer is transmitted to the checkout machine 12 because the child is slow in performing checkout.

### Fourth Embodiment

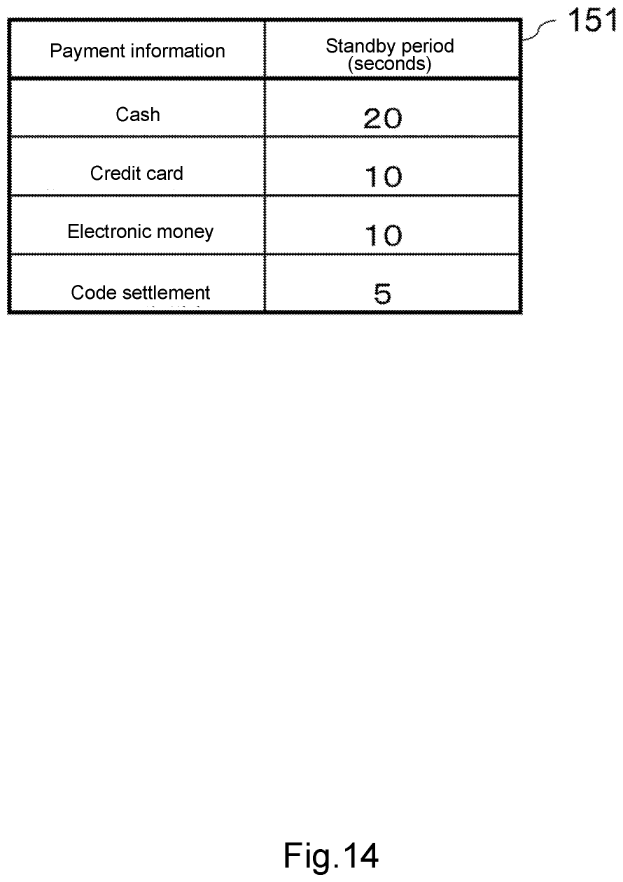

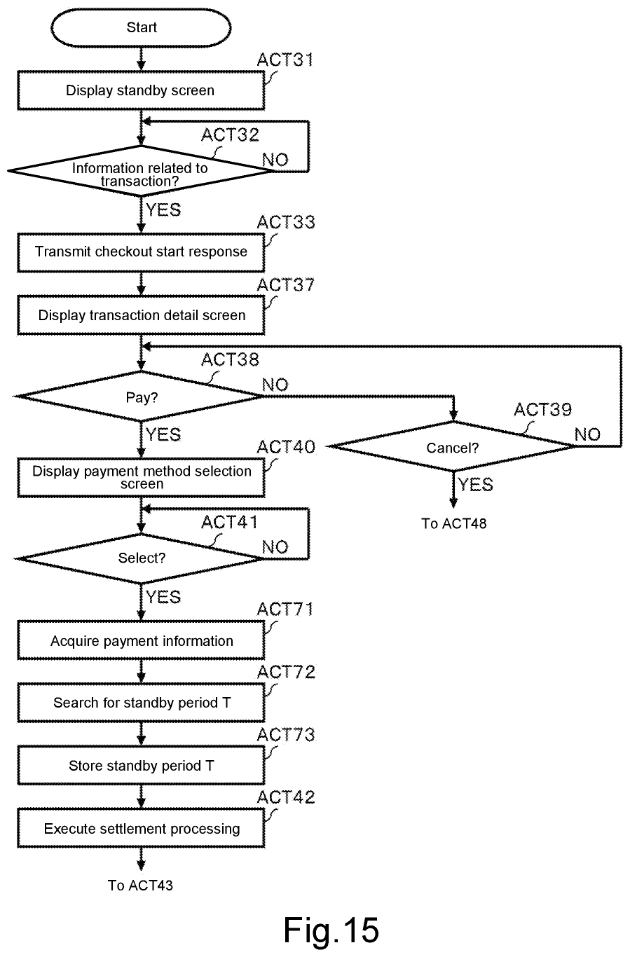

Next, a fourth embodiment will be described with reference to FIGS. 14 and 15 in addition to FIGS. 1 to 9. In the first to third embodiments, the customer information provided to vary the timing at which the checkout machine 12 notifies the register 11 of the fact that information related to a transaction is receivable is the customer segment information such as “adult”, “child”, “elderly person”, and “disabled person”. In the fourth embodiment, a case where the customer information is a payment method and where the timing at which the checkout machine 12 notifies the register 11 of the fact that information related to a transaction is receivable is varied will be described as an example.

The payment method includes payment in cash, by a credit card, by electronic money, by code settlement, and the like. In those payment methods, the code settlement is performed by only holding the screen of a smartphone over the scanner, and thus a customer can move away from the front of the checkout machine 12 immediately after finishing the settlement. Meanwhile, although there is a customer who needs a long time to put a card into a wallet after finishing settlement, the credit payment or the electronic money payment that needs a card is estimated to take a shorter time than picking up change and putting the change in a wallet in the cash payment.

In this regard, in the fourth embodiment, the setting file of the server 13 is assumed as a setting file 151 of a data structure shown in FIG. 14. In other words, the setting file 151 sets a standby period for each payment information (payment method) of cash, credit card, electronic money, and code settlement. Specifically, the server 13 includes a setting file 151 in which the standby period for the payment information “cash” is set to 20 seconds, the standby period for the payment information “credit card” and “electronic money” is set to 10 seconds, and the standby period for the payment information “code settlement” is set to 5 seconds.

In such a fourth embodiment as well, the configuration of the checkout system 10 is similar to that of the first embodiment. The configuration of the register 11 is similar to that of the first embodiment, except that the customer segment keys 361 to 364 are omitted from the keyboard 36. The procedure of the information processing executed by the processor 31 of the register 11 according to the registration program is the procedure excluding the processing of ACT9 in FIG. 7. The response receiving processing is similar to that of the first embodiment. The configuration of the checkout machine 12 is similar to that of the first embodiment. Therefore, FIGS. 1, 2, 3, 4, 5, 6, 7, and 8 apply to the fourth embodiment as they are.

FIG. 15 is a flowchart showing information processing executed by the processor 61 of the checkout machine 12 according to a settlement program. Note that portions at which the same processing as the processing of the first embodiment shown in FIG. 9 is executed are denoted by the same reference symbols shown in FIG. 9. In other words, in ACT31, the processor 61 in a state capable of receiving information related to a transaction causes the touch panel 67 to display a standby screen. In ACT32, the processor 61 waits for information related to a transaction. If information related to a transaction, that is, a transaction information file is received via the communication interface 65, in ACT33, the processor 61 transmits a data signal of a checkout start response to the register 11. Note that, in the register 11, the information processing executed by the processor 31 omits the processing of ACT9 in FIG. 7, and thus the customer segment information is not added to the transaction information file. Therefore, the processor 61 does not execute the processing from ACT34 to ACT36 executed in the first embodiment.

In ACT37, the processor 61 switches the screen of the touch panel 67 to a transaction detail screen. The processor 61 waits until a payment key is operated in ACT38 or a cancel key is operated in ACT39. In the waiting state in ACT38 and ACT39, if the cancel key is input (ACT39: YES), the processing of the processor 61 proceeds from ACT39 to ACT48 shown in FIG. 9. In other words, the processor 61 transmits a data signal of a checkout permission response to the register 11.

In the waiting state in ACT38 and ACT39, if the payment key is input (ACT38: YES), the processing of the processor 61 proceeds from ACT38 to ACT40. In ACT40, the processor 61 switches the screen of the touch panel 67 to a payment method selection screen. In ACT41, the processor 61 waits until any one of the payment methods is selected.

If the cash key, the credit key, the electronic money key, or the code settlement key is operated (ACT41: YES), the processing of the processor 61 proceeds to ACT71. In ACT71, the processor 61 acquires the payment information. In other words, if the cash key is operated for input, the processor 61 acquires the payment information “cash”. If the credit card key is operated for input, the processor 61 acquires the payment information “credit card”. If the electronic money key is input, the processor 61 acquires the payment information “electronic money”. If the code settlement key is input, the processor 61 acquires the payment information “code settlement”. The processing of the processor 61, which has acquired the payment information, proceeds to ACT72. In ACT72, the processor 61 accesses the server 13 to search for a standby period T that is set in the setting file 151 in association with the payment information. In ACT73, the processor 61 stores the standby period T, which has been searched for and retrieved, in the main memory 62.

The processing of the processor 61, which has stored the standby period T, proceeds to ACT42. In ACT42, the processor 61 executes settlement processing corresponding to the payment method. Hereinafter, the processor 61 executes the processing from ACT43 to ACT48 shown in FIG. 9, similarly to the first embodiment.

Here, the processor 61 implements the function as checkout machine-side acquisition means 615 by the processing from ACT71 to ACT73.

In the fourth embodiment described above, the timing at which the checkout machine 12 that has finished the settlement processing notifies the register 11 of the fact that information related to a transaction is receivable can be varied in accordance with the payment method selected by the customer. Therefore, for example, even if there is a customer who is slow in putting change in a wallet because of selecting the cash payment, a notification timing is delayed in the case of the cash payment, so that information related to a transaction of the next customer is not transmitted to the checkout machine 12. Meanwhile, if the payment is performed by the code settlement, a notification timing is advanced as compared to the payment in cash. Even if the notification timing is advanced, the customer performing the code settlement quickly moves away from the front of the checkout machine 12, so there is no problem. Besides, since the notification timing is advanced, processing efficiency in the checkout can be enhanced.

### Modification

In the first embodiment, the customer segment keys 361 to 364 may be replaced with keys, for each of which the standby period is set. In other words, a 10-second key, a 20-second key, and a 30-second key are disposed in the keyboard 36. If the customer is an elderly person or a disabled person, the store clerk operates the 30-second key. If the customer is a child, the store clerk operates the 20-second key. In the case of other customers, the store clerk operates the 10-second key. In ACT9 of FIG. 7, the processor 31 of the register 11 adds the seconds of the key operated for input, to the information related to the transaction. In ACT45 of FIG. 9, the processor 61 of the checkout machine 12 sets the seconds of the key, which are added to the information related to the transaction, in the timer.

With such a configuration as well, the effects similar to those of the first embodiment may be produced. Additionally, such an example does not need to manage the setting file 15 in the server 13 and eliminates the need to access the server 13 because the checkout machine 12 acquires the standby period. This enhances the processing efficiency.

In the first to fourth embodiments, the setting file 15 or the setting file 151 may be managed by each checkout machine 12, instead of being managed in the server 13.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A checkout machine, which performs settlement by an operation of a customer on a basis of information related to a transaction of a commodity to be purchased by the customer, the information related to the transaction being acquired from a register, the checkout machine comprising:
a communication interface that performs data communication with the register;
a memory that stores a standby period, the standby period being a time period that elapses, from a time point at which the settlement is finished, before notifying the register of a fact that the information related to the transaction of the commodity to be purchased is receivable;
a timer; and
a processor configured to
receive the information related to the transaction of the commodity to be purchased from the register via the communication interface,
acquire information of a customer who performs an operation for the settlement,
determine the standby period corresponding to the acquired information of the customer and store the standby period in the memory,
settle the transaction of the commodity to be purchased on a basis of the information related to the transaction of the commodity to be purchased,
determine, using the timer, whether or not the standby period stored in the memory has elapsed from the time point at which the settlement is finished, and
transmit a notification indicating that the information related to the transaction of the commodity to be purchased is receivable to the register via the communication interface at a time point at which the standby period has elapsed.

2. The checkout machine according to claim 1, wherein
the processor acquires the information of the customer from the register via the communication interface.

3. The checkout machine according to claim 2, wherein
the processor acquires the information of the customer from the register together with the information related to the transaction of the commodity to be purchased.

4. The checkout machine according to claim 2, wherein
the processor acquires the information of the customer, which is added to the acquired information related to the transaction of the commodity to be purchased.

5. The checkout machine according to claim 1, wherein
the processor determines the standby period in accordance with the information of the customer to change the standby period depending on the customer.

6. The checkout machine according to claim 1, wherein
the processor acquires the information of the customer, which is input to the register, from the register via the communication interface.

7. The checkout machine according to claim 1, wherein
the information of the customer is information of a customer segment corresponding to an age of the customer.

8. A checkout system, comprising:
a register that registers data of a commodity to be purchased by a customer; and
a checkout machine that performs settlement by an operation of the customer on a basis of information related to a transaction of the commodity to be purchased by the customer, the information related to the transaction being acquired from the register, wherein
the register includes
a first communication interface that performs data communication with the checkout machine,
an input device that inputs information of the customer who purchases the commodity, and
a first processor configured to
create the information related to the transaction of the registered commodity to be purchased,
acquire the information of the customer via the input device, and
receive a notification indicating that the information related to the transaction of the commodity to be purchased is receivable from the checkout machine, and transmit the information related to the transaction of the commodity to be purchased and the information of the customer to the checkout machine via the first communication interface, and wherein
the checkout machine includes
a second communication interface that performs data communication with the register,
a memory that stores a standby period, the standby period being a time period that elapses, from a time point at which the settlement is finished, before notifying the register of a fact that the information related to the transaction of the commodity to be purchased is receivable,
a timer, and
a second processor configured to
receive the information related to the transaction of the commodity to be purchased from the register via the second communication interface,
acquire the information of the customer via the second communication interface,
determine the standby period corresponding to the acquired information of the customer and store the standby period in the memory,
settle the transaction of the commodity to be purchased on a basis of the information related to the transaction of the commodity to be purchased,
determine, using the timer, whether or not the standby period stored in the memory has elapsed from the time point at which the settlement is finished, and
transmit a notification indicating that the information related to the transaction of the commodity to be purchased is receivable to the register via the second communication interface at a time point at which the standby period has elapsed.

9. The checkout system according to claim 8, wherein
the first processor acquires the information of the customer who purchases the registered commodity as information of a customer who operates the checkout machine, and
the second processor determines the standby period in accordance with the acquired information of the customer to change the standby period depending on the customer.

10. A control method for a checkout machine, which performs settlement by an operation of a customer on a basis of information related to a transaction of a commodity to be purchased by the customer, the information related to the transaction being acquired from a register, the control method comprising:
receiving the information related to the transaction of the commodity to be purchased from the register via a communication interface;
acquiring information of a customer who performs an operation for the settlement;
determining a standby period corresponding to the acquired information of the customer and store the standby period in a memory;
settling the transaction of the commodity to be purchased on a basis of the information related to the transaction of the commodity to be purchased;
determining, using a timer, whether or not the standby period stored in the memory has elapsed from a time point at which the settlement is finished; and
transmitting a notification indicating that the information related to the transaction of the commodity to be purchased is receivable to the register via the communication interface at a time point at which the standby period has elapsed.
